(19) United States
(12) Patent Application Publication
(10) Pub. No.: US 2026/0134612 A1
(43) Pub. Date: May 14, 2026

(54) DISPLAY METHOD, COMPUTER-READABLE STORAGE MEDIUM, AND ELECTRONIC DEVICE

(71) Applicant: BOE TECHNOLOGY GROUP CO., LTD., Beijing (CN)

(72) Inventors: Danfeng ZHU, Beijing (CN); Zhe Zhang, Beijing (CN); Kun Li, Beijing (CN); Sujia Jiang, Beijing (CN); Naichuan Chen, Beijing (CN); Ming Gu, Beijing (CN); Yue Yu, Beijing (CN); Jing Yu, Beijing (CN)

(21) Appl. No.: 19/435,827

(22) Filed: Dec. 30, 2025

Related U.S. Application Data
(63) Continuation of application No. PCT/CN2025/075265, filed on Jan. 26, 2025.
(63) Continuation-in-part of application No. 19/167,606.

(51) Int. Cl. G06T 15/10; G06T 7/11; G06T 15/00; G06T 15/04

(52) U.S. Cl. CPC G06T 15/10; G06T 7/11; G06T 15/005; G06T 15/04; G06T 2207/20021

(57) ABSTRACT

A display method includes: creating a global container and a virtual display; determining a display-hidden state of a target pixel; performing image splitting processing on a sub-image whose display-hidden state is a display state in the image to be displayed based on a naked-eye 3D film parameter of the virtual display, to obtain left-right eye views; in a case that the display-hidden state of the target pixel is the display state, determining a current refresh position of the target pixel; performing image interleaving processing on the left-right eye views to obtain a first vector texture; updating the first vector texture according to the current refresh position to obtain a second vector texture after rotation; and pushing the second vector texture to the global container, and outputting the second vector texture to the virtual display based on the global container, to obtain a target stereoscopic image.

### CROSS REFERENCE TO RELATED APPLICATIONS

The present application is a continuation-in-part application of the U.S. patent application Ser. No. 19/167,606, which is a U.S. national stage of International Application No. PCT/CN2023/140915 filed on Dec. 22, 2023, and claims the priority of International Application No. PCT/CN2025/075265 filed on Jan. 26, 2025, the entire contents of both of which are incorporated herein by reference as a part of the present application.

### TECHNICAL FIELD

Embodiments of the present disclosure relate to the field of naked-eye 3D display technology, and in particular, to a display method, a computer-readable storage medium, and an electronic device.

### BACKGROUND

Naked-eye 3D display technology is a display technology that achieves stereoscopic visual effects without the need for external tools, such as 3D glasses. With the rapid development of naked-eye 3D display technology, it has been widely applied to various types of electronic products, such as mobile phones, tablets, handheld game consoles or other mobile terminal devices. In an existing method for information display in the art of naked-eye 3D display, a resource to be displayed, such as an image to be displayed, may be processed based on a hardware interleaving manner to obtain a resource with a naked-eye 3D display effect, and is displayed. In a specific implementation process of hardware interleaving, first, a hardware device is carried, and a video resource signal is intercepted by using the hardware device; and then, the intercepted video resource signal is processed by using the hardware device, to obtain the resource with a naked-eye 3D display effect.

However, the foregoing solution has the following disadvantages: since the processing of the video resource signal completely depends on the hardware device, the video resource signal cannot be directly processed based on the parameter of the display device, thus reducing the adaptability between the naked-eye 3D resource and the display device.

In addition, for mobile terminal devices, due to their mobile characteristics, these devices inevitably experience rotation in complex and ever-changing application scenarios. Especially for a handheld game console, when a user enters a game scene and performs actions according to the game, continuous rotating movement may be caused to the handheld game console over a period of time. However, during the process of the 3D display screen adapting to the rotation direction of the device, stuttering or black screens may occur, and it is not possible to achieve seamless transitions before and after rotation.

It should be noted that the information in the above background of the present disclosure is only used to enhance the understanding of the background of the present disclosure, and therefore may include information that does not constitute the related art known to those of ordinary skill in the art.

### SUMMARY

An objective of the present disclosure is to provide a method for information display, an apparatus information display, a computer-readable storage medium, and an electronic device, so as to overcome the problem of low adaptability between the naked-eye 3D resource and the display device due to limitations and defects in the related art, at least to some extent.

Another objective of the present disclosure is to provide a display method, a computer-readable storage medium, and an electronic device, so as to achieve seamless transitions before and after rotation of the terminal device.

According to an aspect of the present disclosure, there is provided a method for information display, configured to a terminal device, and including:
creating a global container and a virtual display corresponding to the terminal device;
performing, based on a naked-eye 3D film parameter of the virtual display, image splitting processing on a resource to be displayed to obtain left-right eye views with a naked-eye 3D effect;
performing image interleaving processing on the left-right eye views to obtain a current vector texture corresponding to the resource to be displayed; and
pushing the current vector texture to the global container, and outputting the current vector texture to the virtual display based on the global container, to render the current vector texture by using the virtual display.

In some embodiments of the present disclosure, creating the virtual display corresponding to the terminal device includes:
loading a graphics driver model in the terminal device; and
invoking a video present network function in the graphics driver model, and creating the virtual display by using the video present network function.

In some embodiments of the present disclosure, the method for information display further includes:
obtaining extended display identification data of a main display of the terminal device;
determining, based on the extended display identification data, an original screen resolution, an original screen refresh rate, and a number of original viewpoints supportable by the main display; and
generating, according to the original screen resolution, the original screen refresh rate, and the number of original viewpoints, the naked-eye 3D film parameter of the virtual display.

In some embodiments of the present disclosure, creating the global container corresponding to the terminal device includes:

invoking an integrated graphics card in the terminal device based on a multimedia programming interface in the terminal device, and creating the global container corresponding to the terminal device by using the integrated graphics card, where the global container is a modal container, and a background of the global container is a transparent background.

In some embodiments of the present disclosure, performing, based on the naked-eye 3D film parameter of the virtual display, image splitting processing on the resource to be displayed to obtain the left-right eye views with the naked-eye 3D effect includes:
intercepting the resource to be displayed based on a graphics driver model, and establishing a path between the graphics driver model and the integrated graphics card based on a multimedia programming interface in the terminal device;
transmitting the resource to be displayed to the integrated graphics card based on the path between the graphics driver model and the integrated graphics card, and caching the resource to be displayed in the integrated graphics card to a memory processor based on the multimedia programming interface; and
performing, in the memory processor, image splitting processing on the resource to be displayed based on the naked-eye 3D film parameter of the virtual display to obtain the left-right eye views with the naked-eye 3D effect.

In some embodiments of the present disclosure, performing, based on the naked-eye 3D film parameter of the virtual display, image splitting processing on the resource to be displayed to obtain the left-right eye views with the naked-eye 3D effect includes:
determining, based on the naked-eye 3D film parameter of the virtual display, a number of target viewpoints supportable by the virtual display; and
performing image splitting processing on the resource to be displayed based on the number of target viewpoints to obtain the left-right eye views with the naked-eye 3D effect. In some embodiments of the present disclosure, performing image interleaving processing on the left-right eye views to obtain the current vector texture corresponding to the resource to be displayed includes:

invoking a vertex shader and a fragment shader in a memory processor, and calculating an interpolation range of the left-right eye views based on the vertex shader;
calculating interpolation content of the left-right eye views based on the fragment shader; and
performing image interleaving processing on the left-right eye views according to the interpolation range and the interpolation content to obtain the current vector texture corresponding to the resource to be displayed.

In some embodiments of the present disclosure, calculating the interpolation range of the left-right eye views based on the vertex shader includes:
determining an image display range of the left-right eye views on the virtual display, and determining a vertex position of each pixel vertex in the left-right eye views on the virtual display according to the image display range; and
determining the interpolation range of a naked-eye 3D resource by using the vertex shader according to the vertex position of each pixel vertex on the virtual display.

In some embodiments of the present disclosure, calculating the interpolation content of the left-right eye views based on the fragment shader includes:
obtaining a color value arrangement rule of the virtual display, where the color value arrangement rule includes a pixel interval, a number of screen lines, and a maximum offset;
determining a viewpoint interleaving rule of the virtual display according to the number of target viewpoints supportable by the virtual display by using the fragment shader; and
calculating the interpolation content of the left-right eye views according to the viewpoint interleaving rule and the color value arrangement rule.

In some embodiments of the present disclosure, determining the viewpoint interleaving rule of the virtual display according to the number of target viewpoints supportable by the virtual display by using the fragment shader includes:
determining an original pixel matrix of the naked-eye 3D resource;
performing, according to the number of target viewpoints supportable by the virtual display, an orthogonal change of human eye projection corresponding to the number of target viewpoints in the fragment shader to obtain a shader pixel matrix; and
determining the viewpoint interleaving rule of the virtual display according to the shader pixel matrix and the original pixel matrix.

In some embodiments of the present disclosure, determining the viewpoint interleaving rule of the virtual display according to the shader pixel matrix and the original pixel matrix includes:
calculating a product operation result between the shader pixel matrix and the original pixel matrix, and determining the viewpoint interleaving rule of the virtual display according to the product operation result.

In some embodiments of the present disclosure, pushing the current vector texture to the global container, and outputting the current vector texture to the virtual display based on the global container includes:
pushing the current vector texture to the global container, and pushing, based on a multimedia programming interface, the current vector texture in the global container to an independent graphics card in the terminal device; and
replacing a historical vector texture in the independent graphics card based on the current vector texture, and transmitting the current vector texture in the independent graphics card to the virtual display based on a video signal transmission interface in the terminal device.

In some embodiments of the present disclosure, the naked-eye 3D resource includes at least one of a game scene, a video, or an image;
where the method for information display further includes:
performing interaction with a game scene displayed in the virtual display based on a human eye fixation point; and/or
performing, based on an external input event, interaction with a game scene and/or a video and/or an image displayed in the virtual display.

In some embodiments of the present disclosure, performing interaction with the game scene displayed in the virtual display based on the human eye fixation point includes:
obtaining a current fixation point position of the human eye fixation point in the virtual display, and obtaining a central point position of the virtual display;
calculating a position angle between the current fixation point position and the central point position, and controlling a virtual lens in the game scene to rotate from a current position to a target lens position corresponding to the position angle; and
displaying a scene picture shot by the virtual lens at the target lens position.

In some embodiments of the present disclosure, performing, based on the external input event, interaction with the game scene and/or the video and/or the image displayed in the virtual display includes:
capturing, based on the global container, the external input event acting on the game scene and/or the video and/or the image by using the virtual display; and
transparently transmitting the external input event to an event processing layer based on the global container, and processing the external input event based on the event processing layer, to implement interaction with the game scene and/or the video and/or the image.

According to an aspect of the present disclosure, there is provided an apparatus information display, configured in a terminal device, and including:
a virtual display creation module, configured to create a global container and a virtual display corresponding to the terminal device;
an image splitting processing module, configured to perform, based on a naked-eye 3D film parameter of the virtual display, image splitting processing on a resource to be displayed to obtain left-right eye views with a naked-eye 3D effect;
an image interleaving processing module, configured to perform image interleaving processing on the left-right eye views to obtain a current vector texture corresponding to the resource to be displayed; and
a vector texture rendering module, configured to push the current vector texture to the global container, and output the current vector texture to the virtual display based on the global container, to render the current vector texture by using the virtual display.

According to an aspect of the present disclosure, there is provided a display method, performed by a terminal device, and including:
creating a global container and a virtual display corresponding to the terminal device;
determining, according to at least one of an original position of a target pixel in an image to be displayed that is obtained or a rotation angle of the terminal device that is received, a display-hidden state of the target pixel;
performing image splitting processing on a sub-image whose display-hidden state is a display state in the image to be displayed based on a naked-eye 3D film parameter of the virtual display, to obtain left-right eye views corresponding to the sub-image;
in a case that the display-hidden state of the target pixel is the display state, determining a current refresh position of the target pixel based on at least the original position of the target pixel;
performing image interleaving processing on the left-right eye views to obtain a first vector texture corresponding to the sub-image;
updating the first vector texture according to the current refresh position to obtain a second vector texture after rotation; and
pushing the second vector texture to the global container, and outputting the second vector texture to the virtual display based on the global container, to obtain a target stereoscopic image by rendering the second vector texture using the virtual display.

According to an aspect of the present disclosure, there is provided a computer-readable storage medium having a computer program stored thereon, where the computer program, when executed by a processor, implements the method for information display according to any one of the above embodiments.

According to an aspect of the present disclosure, there is provided an electronic device, including:
a processor; and
a memory, configured to store an executable instruction by the processor;
where the processor is configured to perform the method for information display according to any one of the above embodiments by executing the executable instruction.

According to the method for information display provided in the embodiments of the present disclosure, on one hand, a virtual display and a global container corresponding to the terminal device are created; image splitting processing is then performed on the resource to be displayed based on a naked-eye 3D film parameter of the virtual display to obtain left-right eye views with a naked-eye 3D effect; then, image interleaving processing is performed on the left-right eye views to obtain a current vector texture corresponding to the resource to be displayed; finally, the current vector texture is pushed to the global container, and the current vector texture is output to the virtual display based on the global container, to render the current vector texture by using the virtual display, so that software interleaving of the resource to be displayed is achieved, and the resource to be displayed may be directly processed based on the naked-eye 3D film parameter to obtain the current vector texture, thus improving the adaptability between the current vector texture and the virtual display. On the other hand, image splitting processing is performed on the resource to be displayed based on the naked-eye 3D film parameter of the virtual display to obtain the left-right eye views with the naked-eye 3D effect, and then, image interleaving processing is performed on the left-right eye views to obtain the current vector texture corresponding to the resource to be displayed, so that the accuracy of the current vector texture may be improved, and the accuracy of the rendering result of the current vector texture may be further improved.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of the specification, illustrate embodiments consistent with the present disclosure and, together with the description, serve to explain the principles of the present disclosure. Obviously, the accompanying drawings in the following description are merely some embodiments of the present disclosure. For those of ordinary skill in the art, other drawings may be obtained according to these drawings without creative efforts.

FIG. 1 schematically shows a flowchart of a method for information display according to some embodiments of the present disclosure.

FIG. 2 schematically shows an example diagram of an architecture of a display driver model according to some embodiments of the present disclosure.

FIG. 3 schematically shows an example diagram of an architecture of a terminal device according to some embodiments of the present disclosure.

FIG. 4 schematically shows a scene example diagram of left-right eye views with 2 viewpoints according to some embodiments of the present disclosure.

FIG. 5 schematically shows a scene example diagram of left-right eye views with 9 viewpoints according to some embodiments of the present disclosure.

FIG. 6 schematically shows a scene example diagram of left-right eye views with 16 viewpoints according to some embodiments of the present disclosure.

FIG. 7 schematically shows a scene example diagram obtained by performing an image zooming-out interaction operation according to some embodiments of the present disclosure.

FIG. 8 schematically shows a scene example diagram obtained by performing an image zooming-in interaction operation according to some embodiments of the present disclosure.

FIG. 9 schematically shows a block diagram of an apparatus for information display according to some embodiments of the present disclosure.

FIG. 10 is a distribution diagram of sub-areas divided for the display terminal according to some embodiments of the present disclosure.

FIG. 11 schematically shows an electronic device for implementing the above method for information display according to some embodiments of the present disclosure.

### DETAILED DESCRIPTION

Example embodiments will now be described more fully with reference to the accompanying drawings. Example embodiments, however, can be implemented in various forms and should not be construed as limited to the embodiments set forth herein; by contrast, these embodiments are provided so that the present disclosure will be thorough and complete, and will fully convey the concept of example embodiments to those skilled in the art. The described features, structures, or characteristics may be combined in any suitable manner in one or more embodiments.

In addition, the accompanying drawings are merely schematic illustrations of the present disclosure and are not necessarily drawn to scale. The same reference numerals in the drawings denote the same or similar parts, and thus their repeated description will be omitted. Some block diagrams shown in the accompanying drawings are functional entities and do not necessarily correspond to physically or logically independent entities. These functional entities may be implemented in software form, or implemented in one or more hardware modules or integrated circuits, or implemented in different networks and/or processor apparatuses and/or microcontroller apparatuses.

In the present example embodiment, there is first provided a method for information display. The method may be run on a terminal device, or certainly may be run on a server, a server cluster, a cloud server, etc. Of course, those skilled in the art may also run the method of the present disclosure on other platforms according to requirements, which is not specifically limited in the present example embodiment. In some embodiments, the terminal device described here may include a terminal device (for example, a conference all-in-one machine or a smart city display screen), or may include a personal computer, a tablet computer, a desktop computer, or the like, which are not specifically limited in this example.

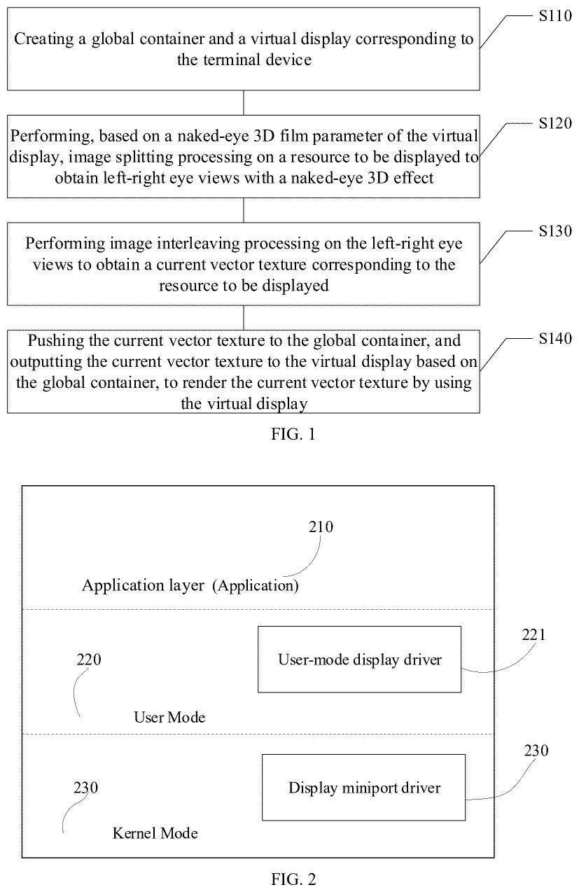

In some embodiments, referring to FIG. 1, the method for information display may include the following steps.

In step S110, a global container and a virtual display corresponding to the terminal device are created.

In step S120, based on a naked-eye 3D film parameter of the virtual display, image splitting processing is performed on the resource to be displayed to obtain left-right eye views with a naked-eye 3D effect.

In step S130, image interleaving processing is performed on the left-right eye views to obtain a current vector texture corresponding to the resource to be displayed.

In step S140, the current vector texture is pushed to the global container, and the current vector texture is output to the virtual display based on the global container, to render the current vector texture by using the virtual display.

In the above method for information display, on one hand, a virtual display and a global container corresponding to the terminal device are created; image splitting processing is then performed on the resource to be displayed based on a naked-eye 3D film parameter of the virtual display to obtain left-right eye views with a naked-eye 3D effect; then, image interleaving processing is performed on the left-right eye views to obtain a current vector texture corresponding to the resource to be displayed; finally, the current vector texture is pushed to the global container, and the current vector texture is output to the virtual display based on the global container, to render the current vector texture by using the virtual display, so that software interleaving of the resource to be displayed is achieved, and the resource to be displayed may be directly processed based on the naked-eye 3D film parameter to obtain the current vector texture, thus improving the adaptability between the current vector texture and the virtual display. On the other hand, image splitting processing is performed on the resource to be displayed based on the naked-eye 3D film parameter of the virtual display to obtain the left-right eye views with the naked-eye 3D effect, and then, image interleaving processing is performed on the left-right eye views to obtain the current vector texture corresponding to the resource to be displayed, so that the accuracy of the current vector texture may be improved, and the accuracy of the rendering result of the current vector texture may be further improved.

In the following, the method for information display described in the example embodiment of the present disclosure will be further explained and described with reference to the accompanying drawings.

Firstly, terms involved in the example embodiments of the present disclosure are explained.

Global processing means processing of the displayed image on the Windows system level of the terminal device, which is not singly directed to any application program or displayed content running on the system, but is directed to all displayed images included in the terminal device, for example, the image displayed by the display system, the interaction and response brought by the peripheral equipment such as the Mouse/KeyBoard/TouchBar, etc. In some embodiments, the interaction and response brought by the peripheral equipment may include operations such as a pause operation on the player performed by using the space key, fast forward and fast backward operations performed by using the left key and the right key, or the like.

Software interleaving (SoftWareInterweave) refers to a process of completing corresponding image interleaving processing by using a driver or an application on the Windows system level of a terminal device to obtain a corresponding pixel arrangement and rendering display.

WDDM refers to a display driver model of the Windows display driver model, and its full name is Windows Display Driver Model. In an actual application process, the display driver model (DDM) architecture consists of a user mode part and a kernel mode part, which may be referred to FIG. 2. In some embodiments, in the architecture of the display driver model shown in FIG. 2, an application layer (Application) 210, a user mode 220, and a kernel mode 230 may be included. In some embodiments, in the user mode, the graphics hardware provider has to provide a user-mode display driver 221; and in the kernel mode, the graphics hardware provider has to provide a display miniport driver 231. In some embodiments, the display miniport driver described here may also be referred to as a kernel-mode driver (KMD). Further, the user-mode display driver is a dynamic link library (DLL) file loaded during running of Direct3D, and the display miniport driver communicates with the DirectX graphics kernel subsystem.

It should be noted here that, the WDDM involved in the present disclosure is a miniport driver conforming to the Windows driver model (WDM) specification, and has a power management function, where loading of the WDDM may be implemented in a plug-and-play (PnP) manner. In an actual application process, the specific application functions of the WDDM may be classified into three categories: one is a callback function driven by a common WDM, such as DxgkDdiAddDevice, DxgkDdiStartDevic, or the like, which corresponds to an AddDevice function and an IRP_MN_START_DEVICE request in the WDM; another one is a direct data ingestion (DDI) function, which is an image related function, and image resource allocation and mouse shape drawing may be performed based on this function; and another one is a video present network (VIDPN) function for managing the VIDPN. In an actual application process, if an additional terminal device (a virtual display) needs to be simulated, it may be implemented by modifying a VIDPN related function.

DirectX (Direct extension, referred to as DX) is a multimedia programming interface created by Microsoft Corporation, and is an application program interface (API). DirectX may enable a game or multimedia program with Windows as a platform to obtain higher execution efficiency, enhance 3D graphics and sound effects, and provide a common hardware drive standard for designers, so that a game developer does not need to write different drivers for each brand of hardware, and the complexity of installation and setting of hardware by the user may also be reduced. Microsoft DirectX is intended to enable a Windows-based computer to be an ideal platform for running and displaying applications with rich multimedia elements (e.g. panchromatic graphics, video, 3D animation, and rich audio). DirectX includes security and performance update programs, as well as many new functions that encompass all technologies, and applications may access these new functions by using DirectX API.

Virtual display. A virtual display may also be referred to as desktop virtualization, or may also be referred to as a virtual desktop infrastructure, which is a server-based computing model. Although the model of the traditional thin client is used in the virtual display, the administrator and the user can simultaneously obtain the advantages of both modes: one is that all desktop virtual machines are hosted and managed in a unified manner in the data center; and anther one is that, the use experience of a complete PC can be obtained by the user, and the technology for implementing remote dynamic access to the desktop system as well as data center unified hosting at the enterprise level is supported.

Secondly, technical implementation principles of example embodiments of the present disclosure are explained and described. In some embodiments, the method for information display described in the example embodiments of the present disclosure provides a solution for developing a graphics card filter driver by using the Windows driver layer and performing global software interleaving by using the DirectX technology under the Windows platform, so as to implement a display form with global software interleaving and complete display of naked-eye 3D related content. Further, in the method for information display described in the present disclosure, the main display needs to be switched by using the virtual display, because there is a DPI (Dots Per Inch) attribute in the Windows system. The function of the attribute in image display is to zoom-out or zoom in the corresponding system user interface (UI) as a whole under a customized resolution. If the resolution or DPI of the original display is used, it may result in that the actual resolution in the full-screen state cannot reach the target resolution of 4K or above, and there is a false 4K display. In some embodiments, if the DPI of the target display device or the DPI of the system is forcibly modified under the original resolution by using the Windows API, it may result in that the icon of the user at the client is disordered, and the user experience is reduced. Therefore, a virtual display needs to be used. In some embodiments, in an actual application process, a default attribute may be allocated to the virtual display by using the attribute of the target display device. For example, the allocated default attribute here is 3840*2160, and the DPI is 100%.

Further, after the virtual display is created by using the WDDM, the system will give a default globally unique identifier class (GUID_Class) to the virtual display, the value of which is unique in the system, so that it may also ensure that the interface habit of the user and the system layout, such as the icon size and the icon arrangement manner on the display interface, may be reserved, no matter how many times the virtual display is turned off or turned on. In addition, if the WinAPI is used to forcibly set the DPI on the existing display, it may result in that the screen flickers. This problem may also be avoided by setting the parameter of the virtual display firstly and then switching the main display.

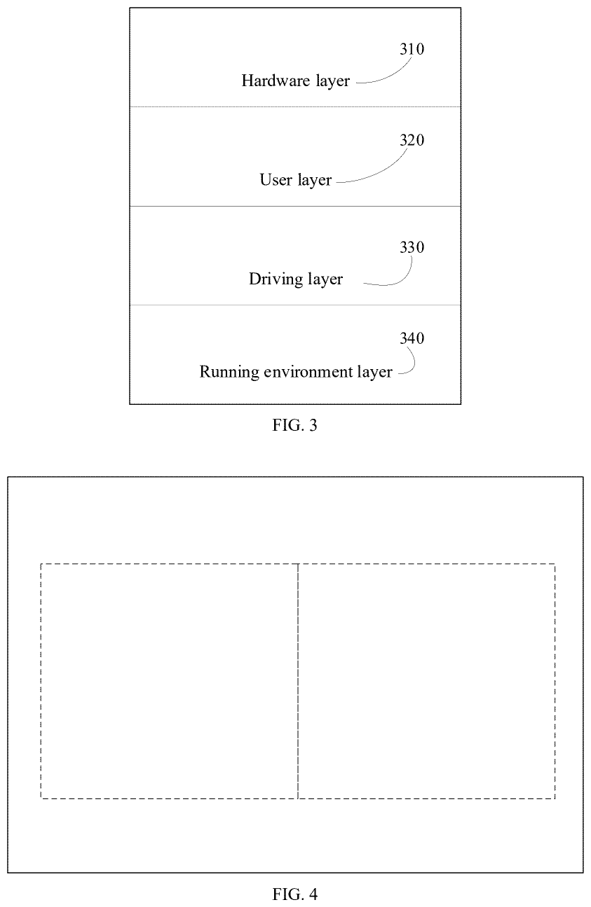

Further, the system overall architecture of the terminal device described in the example embodiments of the present disclosure is explained and described. In some embodiments, referring to FIG. 3, the system overall architecture may include a hardware layer 310, a user layer 320, a driving layer 330, and a running environment layer 340.

In some embodiments, the hardware layer may include a display corresponding to the terminal device, an external device (such as a mouse, a keyboard, etc.), and another host adapted to the naked-eye 3D.

The user layer may include a user layer starting module and a user interaction module; and the user interaction module may include a multimedia file browsing interaction, an independent applicable starting interaction, or the like.

The driving layer may include a video memory management module, a video memory replacement module, a frame processing module, a pixel processing module, a system log module, or the like.

The running environment layer may include a Windows system running environment, or the like.

In some embodiments, the resource to be displayed described in the example embodiment of the present disclosure is mainly derived from a UMDF (User-Mode Driver Framework) layer driver, that is, a GPU (Graphics Processing Uni) change initiated by a user layer driver, which is commonly referred to as a display change, for example, a behavior such as staring a third-party application by the user or playing a multimedia file, etc. In an actual application process, the interaction behavior of the user may cause a corresponding change of the GPU. However, no matter what kind of change, the unique output port of the data is to convert from the GPU to the display. Therefore, according to the method for information display described in the example embodiments of the present disclosure, the 2-level cache may be performed to the CPU by using the address COPY in the GPU, so that no matter what modification is performed on the frame, the corresponding essential display content is not affected. However, different resolutions and refresh rates may be displayed according to different virtual displays, and the virtual display is extended by using extended display identification data (EDID), so that the refresh rate of the virtual display may be equivalent to the hardware device. Therefore, in the method for information display described in the example embodiments of the present disclosure, during data pushing, the specific pushing process is: GPU→CPU→GPU. Therefore, even if 2-level cache is performed, the delay is relatively non-inductive for the user. Of course, there must be a delay for the data flow itself due to the addition of the corresponding data processing, but this delay is completed before conversion form the GPU to the virtual display, so it is non-inductive and acceptable for the client (i.e., the client corresponding to the application) user.

In the following, the method for information display shown in FIG. 1 will be further explained and described with reference to FIG. 2 and FIG. 3.

In step S110, a global container and a virtual display corresponding to the terminal device are created.

In the example embodiment, firstly, a virtual display corresponding to the terminal device is created. In some embodiments, the specific creation process of the virtual display may be implemented in the following manner: firstly, a graphics driver model in the terminal device is loaded; and then, a video present network function in the graphics driver model is invoked, and the virtual display is created by using the video present network function. That is, in an actual application process, if a virtual display corresponding to a target display of the terminal device needs to be created, a graphics driver model needs to be installed, where the installation of the graphics driver model may be implemented based on a plug-and-play manner. For example, the graphics driver model may be installed on a chip; and if the graphics driver model needs to be installed, the graphics driver model may be directly installed on the terminal device in a pluggable manner, and the graphics driver model may be loaded from the chip. After the graphics driver model is installed, the graphics driver model may be driven; and the virtual display corresponding to the target display may be created based on the graphics driver model.

In some embodiments, in the process of creating the virtual display, it is firstly needed to determine whether the terminal device includes a plurality of target displays. If a plurality of target displays is included, a main display needs to be determined from the plurality of target displays, and the virtual display is created based on the main display. If only one target display is included, the virtual display is created based on the target display. In some embodiments, after the virtual display is created, no matter how many target displays the terminal device has, the virtual display needs to be used as the main display.

In some embodiments, in the process of creating the virtual display based on the graphics driver model, firstly, a video present network function in the graphics driver model needs to be invoked, and then the virtual display is created based on the video present network function; then, a globally unique identifier class is allocated to the virtual display, where the globally unique identifier class is allocated by the Windows system by default and is used to uniquely identify the virtual display. It should be noted here that, the globally unique identifier class (GUID_Class) needs to be allocated, because no matter how many times the virtual display is turned on or turned off, the system layout of the user interface on the virtual display may be invoked based on the GUID_Class, thus avoiding the problem of display disorder.

In some embodiments, after the virtual display is successfully created, the naked-eye 3D film parameter may be configured for the virtual display. In some embodiments, the specific configuration process of the naked-eye 3D film parameter may be implemented in the following manner. Firstly, extended display recognition data of the main display of the terminal device is obtained. Secondly, based on the extended display identification data, an original screen resolution, an original screen refresh rate, and a number of original viewpoints supportable the main display are determined. Then, according to the original screen resolution, the original screen refresh rate, and the number of original viewpoints, the naked-eye 3D film parameter of the virtual display is generated. In some embodiments, since the EDID includes the provider information, the maximum image size, the color setting, the manufacturer preset, the frequency range limitation, the character string of the serial number and the display name of the main display, or the like, the original screen resolution, the original screen refresh rate and the number of original viewpoints of the main display may be determined based on the extended display recognition data, thus the naked-eye 3D film parameter of the virtual display is determined based on the original screen resolution, the original screen refresh rate and the number of original viewpoints, where the target screen resolution, the target screen refresh rate, and the number of target viewpoints in the naked-eye 3D film parameter may be kept consistent with the original screen resolution, the original screen refresh rate, and the number of original viewpoints.

Secondly, a global container corresponding to the terminal device is created. In some embodiments, it may be implemented in the following manner. Based on a multimedia programming interface in the terminal device, an integrated graphics card in the terminal device is invoked, and a global container corresponding to the terminal device is created by using the integrated graphics card, where the global container is a modal container, and a background of the global container is a transparent background. That is, in an actual application process, in order to not occupy the resources for the independent graphics card of the terminal device, the global container may be established by using the integrated graphics card. In some embodiments, the global container needs to be established, so as to perform software interleaving on all resources to be displayed in the terminal device. Certainly, based on the global container, event transparent transmission of a mouse event, a keyboard event, or a touch event may also be performed, so as to implement interaction with the displayed resource based on the event. For example, based on the mouse event, the keyboard event, or the touch event, the resource displayed by a player is paused, fast forwarded, amplified, or the like. For another example, based on the mouse event, the keyboard event, or the touch event, the game scene displayed by the virtual display is switched, or the virtual object is controlled.

In step S120, based on the naked-eye 3D film parameter of the virtual display, image splitting processing is performed on the resource to be displayed to obtain left-right eye views with a naked-eye 3D effect.

In some embodiments, performing image splitting processing on the resource to be displayed based on the naked-eye 3D film parameter of the virtual display to obtain the left-right eye views with the naked-eye 3D effect may be implemented in the following manner. The resource to be displayed is intercepted based on the graphics driver model, and a path between the graphics driver model and the integrated graphics card is established based on the multimedia programming interface in the terminal device; the resource to be displayed is transmitted to the integrated graphics card based on the path between the graphics driver model and the integrated graphics card, and the resource to be displayed in the integrated graphics card is cached to a memory processor based on the multimedia programming interface; and, in the memory processor, image splitting processing is performed on the resource to be displayed based on the naked-eye 3D film parameter of the virtual display to obtain the left-right eye views with the naked-eye 3D effect. That is, in an actual application process, in order to implement global software interleaving on the resource to be displayed, the resource to be displayed may be intercepted by using the graphics driver model, and the resource to be displayed is intercepted before the resource to be displayed is processed, so that the problem of hardware resource waste caused by resource interception by using the hardware may be avoided. In some embodiments, after the resource to be displayed is intercepted by using the graphics driver model, the resource to be displayed may be transmitted to the integrated graphics card based on the multimedia programming interface DirectX, then the resource to be displayed may be transmitted to the memory processor from the integrated graphics card based on the multimedia programming interface DirectX, and image splitting processing and image interleaving processing may be performed based on the memory processor to obtain the current vector texture. In some embodiments, the resource to be displayed described here may be a video resource to be displayed or an image resource to be displayed loaded by the target application, or may be a game scene to be displayed loaded by the target application; or may be a video resource to be displayed or an image resource to be displayed that is directly selected, which is not specifically limited in this example.

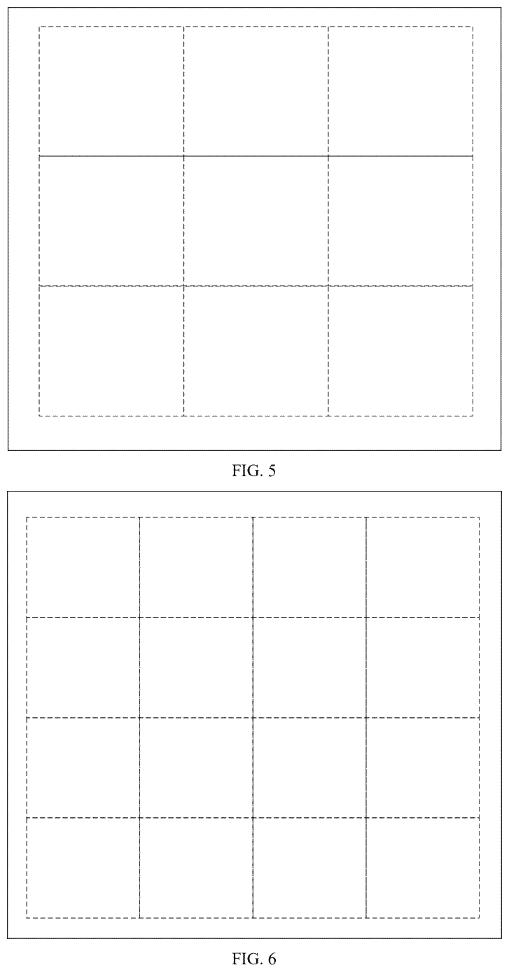

In some embodiments, performing image splitting processing on the resource to be displayed based on the naked-eye 3D film parameter of the virtual display to obtain the left-right eye views with the naked-eye 3D effect may be implemented in the following manner. Firstly, the number of target viewpoints supportable by the virtual display is determined based on the naked-eye 3D film parameter of the virtual display; then, image splitting processing is performed on the resource to be displayed based on the number of target viewpoints to obtain the left-right eye views with the naked-eye 3D effect. That is, in an actual application process, the resource to be displayed may be split into left-right eye views based on the number of target viewpoints, where the left-right eye views may also be referred to as a SidebySide image, and the number of target viewpoints described here may include 2 viewpoints, 9 viewpoints, 16 viewpoints, 49 viewpoints, etc. The left-right eye views that is obtained may include a 2-viewpoint image, a 9-viewpoint image, a 16-viewpoint image, or a 49-point image, etc. In some embodiments, the 2-viewpoint image may refer to FIG. 4, the 9-viewpoint image may refer to FIG. 5, and the 16-viewpoint image may refer to FIG. 6. It should be noted here that, the resource to be displayed needs to be split into the left-right eye views, so as to determine the number of multi-viewpoint images based on the number of target viewpoints supportable by the virtual display. Image interleaving is required to implement the naked-eye 3D effect on the virtual display.

In step S130, image interleaving processing is performed on the left-right eye views to obtain a current vector texture corresponding to the resource to be displayed.

In some embodiments, performing image interleaving processing on the left-right eye views to obtain the current vector texture corresponding to the resource to be displayed may be implemented in the following manner. A vertex shader and a fragment shader in the memory processor are invoked, and an interpolation range of the left-right eye views is calculated based on the vertex shader; interpolation content of the left-right eye views is calculated based on the fragment shader; and image interleaving processing is performed on the left-right eye views according to the interpolation range and the interpolation content to obtain the current vector texture corresponding to the resource to be displayed.

In some embodiments, calculating the interpolation range of the left-right eye views based on the vertex shader may be implemented in the following manner. An image display range of the left-right eye views on the virtual display is determined, and a vertex position of each pixel vertex in the left-right eye views on the virtual display is determined according to the image display range; and, the interpolation range of the naked-eye 3D resource is determined by using the vertex shader according to the vertex position of each pixel vertex on the virtual display.

In some embodiments, calculating the interpolation content of the left-right eye views based on the fragment shader may be implemented in the following manner. A color value arrangement rule of the virtual display is obtained, where the color value arrangement rule includes a pixel interval, a number of screen lines, and a maximum offset; a viewpoint interleaving rule of the virtual display is determined according to the number of target viewpoints supportable by the virtual display by using the fragment shader; and the interpolation content of the left-right eye views is calculated according to the viewpoint interleaving rule and the color value arrangement rule.

In some embodiments, determining the viewpoint interleaving rule of the virtual display according to the number of target viewpoints supportable by the virtual display by using the fragment shader may be implemented in the following manner. An original pixel matrix of the naked-eye 3D resource is determined; according to the number of target viewpoints supportable by the virtual display, an orthogonal change of human eye projection corresponding to the number of target viewpoints is performed in the fragment shader to obtain a shader pixel matrix; and the viewpoint interleaving rule of the virtual display is determined according to the shader pixel matrix and the original pixel matrix.

In some embodiments, determining the viewpoint interleaving rule of the virtual display according to the shader pixel matrix and the original pixel matrix may be implemented in the following manner. A product operation result between the shader pixel matrix and the original pixel matrix is calculated, and the viewpoint interleaving rule of the virtual display is determined according to the product operation result.

The specific interleaving process of the left-right eye views will be explained and described below. In some embodiments, since the left-right eye views themselves need to be different, that is, both the left view and the right view have their ranges and corresponding edge values, the left-right eye views need to be processed by using the shader before the left-right eye views are rendered. In some embodiments, the shader described here may include a vertex shader and a fragment shader.

The vertex shader may also be referred to as Vertshader, and may be used to determine the display range of the left-right eye views, for example, to determine that the left-right eye views are interleaved into 1K, 2K, or 4K. In an actual application process, the vertex shader may act on each pixel vertex in the naked-eye 3D resource and generate a final position for each pixel vertex. In some embodiments, for each pixel vertex, the vertex shader is executed once to determine the final position of the pixel vertex. Further, once the final position of each pixel vertex is determined, the set of these visible vertices may be assembled by the GPU into a point, a straight line, and a triangle, thus improving the speed of rendering the scene and the model. In addition, since the sizes of the left-right eye views themselves are equivalent to half of the target view, it is needed to determine the positions of the pixel vertices in the left-right eye views, so as to perform multi-viewpoint image interleaving.

The fragment shader may also be referred to as a PixShader, and may be used to determine the interpolation content in the interleaving process. In some embodiments, since interleaving is equivalent to that the RGB/RGBA values are inserted into regions according to a certain rule, the function of the shader is to insert the pixel values correspondingly interleaved into the corresponding positions in the main display to cooperate with the 3D film (i.e., the virtual display) for naked-eye display. This depends on two factors. One factor is the RGB arrangement rule of the main display. The RGB arrangement rule of the main display may include but is not limited to a pixel interval, a number of screen lines, a maximum offset, etc. The RGB arrangement rule of the main display may be determined based on the extended display identification data of the main display. The other factor is the viewpoint interleaving rule. In an actual application process, for 2 viewpoints and 9 viewpoints, the number of shader pixel matrixes needs to be processed are different. The higher the number of viewpoints is, the higher the matrix number is, but the matrix size is reduced, because the length and width of a single view are reduced. Therefore, the shader pixel matrix needs to be calculated based on the fragment shader, thus the viewpoint interleaving rule is determined based on the shader pixel matrix and the original pixel matrix.

It should be further noted here that, based on the content described above, it can be learned that the vertex shader described above may be used to determine the interpolation range of the left-right eye views, and the fragment shader may be used to determine the interpolation content of the left-right eye views. Based on this, after interleaving processing is performed on the left-right eye views by the memory processor, the GPU may perform rendering according to a specified rule, specified content, and a specified range. In some embodiments, in addition to global interleaving, parameters and ranges may be dynamically allocated, and interleaving may be performed in any size at any position of the screen to implement local naked-eye 3D. Of course, the implementation of local naked-eye 3D depends on whether the corresponding main display has a 3D film or hardware capability in this manner.

In step S140, the current vector texture is pushed to a global container, and the current vector texture is output to the virtual display based on the global container, to render the current vector texture by using the virtual display.

In some embodiments, pushing the current vector texture to a global container, and outputting the current vector texture to the virtual display based on the global container may be implemented in the following manner. The current vector texture is pushed to the global container, and the current vector texture in the global container is pushed to an independent graphics card in the terminal device based on a multimedia programming interface; and, a historical vector texture in the independent graphics card is replaced based on the current vector texture, and the current vector texture in the independent graphics card is transmitted to the virtual display based on a video signal transmission interface in the terminal device. That is, in an actual application process, after the current vector texture is obtained, the current vector texture may be pushed to a full-screen container by using a corresponding data stream pushing channel; and, after the full-screen container receives the current vector texture, the current vector texture may be pushed to the independent graphics card based on the multimedia programming interface. Then, the independent graphics card replaces the historical vector texture in the independent graphics card based on the current vector texture, and assembles the set of pixel vertexes into points, straight lines and triangles based on the interpolation range in the current vector texture, thus achieving the purpose of improving the rendering speed of the model to be rendered and the scene to be rendered in the resource to be rendered.

Further, after the set of pixel vertices is assembled, based on the video signal transmission interface, the current vector texture in the independent graphics card is transmitted to the virtual display, where the video signal transmission interface described here may include a high definition multimedia interface (HDMI) or a DisplayPort (DP) interface. After the virtual display receives the current vector texture, the current vector texture may be rendered to implement display of the resource to be displayed.

In some embodiments, after the display of the resource to be displayed is completed, the method for information display further includes: performing interaction with a game scene displayed in the virtual display based on a human eye fixation point; or, performing, based on an external input event, interaction with a game scene and/or a video and/or an image displayed in the virtual display. In other words, in an actual application process, the displayed game scene may also be switched by means of a human eye position change; or, interactions such as game scene switching, video pause, video fast forward, video fast backward, and image zooming-in may be performed by means of an external input event (such as a mouse input event, a keyboard input event, or a screen input event).

In some embodiments, performing interaction with the game scene displayed in the virtual display based on the human eye fixation point may be implemented in the following manner. A current fixation point position of the human eye fixation point in the virtual display is obtained, and a central point position of the virtual display is obtained. A position angle between the current fixation point position and the central point position is calculated, and a virtual lens in the game scene is controlled to rotate from a current position to a target lens position corresponding to the position angle; and, a scene picture shot by the virtual lens at the target lens position is displayed. In other words, the current human eye image of the user may be collected by the image acquisition device corresponding to the main display, and the current fixation point position of the human eye fixation point is determined based on the current human eye image. If the fixation point position changes, the virtual lens may be controlled to rotate based on the corresponding position angle, so as to implement switching of the game scene.

In some embodiments, performing, based on the external input event, interaction with the game scene and/or the video and/or the image displayed in the virtual display may be implemented in the following manner. Based on the global container, the external input event acting on the game scene and/or the video and/or the image is captured by using the virtual display; and, the external input event is transparently transmitted to an event processing layer based on the global container, and the external input event is processed based on the event processing layer, to implement interaction with a game scene and/or a video and/or an image. That is, if it is necessary to implement game scene interaction or video interaction or image interaction through an external input event, it is necessary to implement the game scene interaction or video interaction or image interaction through a global container; in the actual application process, the external input event is captured based on the global container, and then the external input event is transmitted to the event processing layer, so as to perform event processing based on the event processing layer to implement a corresponding interaction process.

For example, if a game scene is displayed in the virtual display, when an external input event is captured, game scene switching may be performed, or a skill may be released, or other interaction operations may be performed, which is not specifically limited in this example.

For another example, if a video is displayed in the virtual display, when an external input event is captured, video pause, video fast forward or video fast backward, etc., may be performed; or, full-screen display, local display, etc., may also be performed, which is not specifically limited in this example.

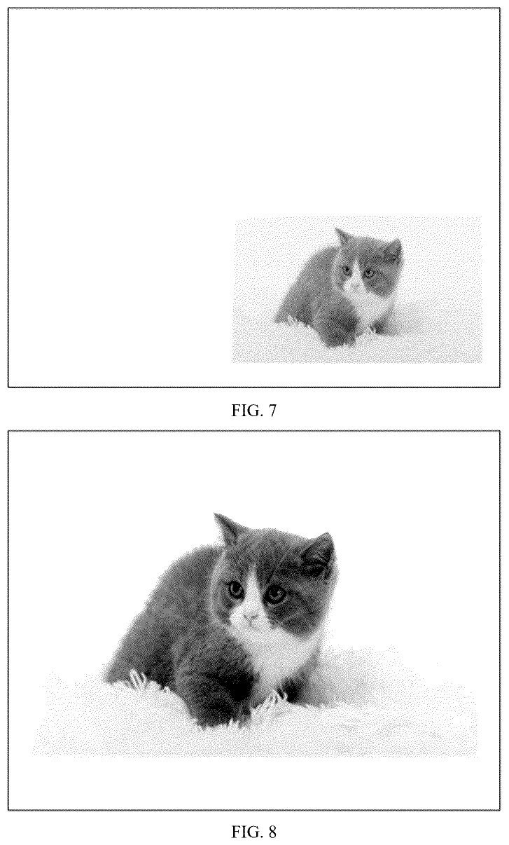

For another example, if an image is displayed in the virtual display, when an external input event is captured, image zooming-in or image zooming-out may be performed, where the scene example diagram obtained by performing the image zooming-out interaction operation may refer to FIG. 7, and the scene example diagram obtained by performing the image zooming-in interaction operation may refer to FIG. 8.

Here, the method for information display described in the example embodiments of the present disclosure has been implemented completely. Based on the foregoing content, it may be learned that, according to the method for information display described in the example embodiments of the present disclosure, a virtual display may be created on the integrated graphics card by using the WDDM technology, and software interleaving may be performed by using the DX technology, the advantage of which is that the performance consumption of the independent graphics card may not be occupied. If the user runs a high-consumption program on the independent graphics card at this time, the user experience may not be affected. In addition, the method for information display described in the present disclosure is different from the interleaving scheme of hardware interleaving in software level. In the hardware interleaving processing scheme, processing is performed on the product layer of the image signal; since there is currently two types of mainstream signal transmission, HDMI and DP, the two types of signal protocols need to be processed, and additional hardware devices for signal parsing and processing such as FPGA or K3 board needs to be added at the hardware layer. The method for information display provided in the present disclosure is a Windows system layer scheme based on the integrated graphics card, in which images are processed from the source and there is no other dependency on the signal transmission device. Further, since the underlying technology used in the method for information display described in the present disclosure is based on the Windows system layer, and there is no additional dependency, it is updated with the Windows system without additional adaptation.

The following is an apparatus embodiment of the present disclosure, which may be used to perform the method embodiments of the present disclosure. For details not disclosed in the apparatus embodiment of the present disclosure, reference may be made to the method embodiments of the present disclosure.

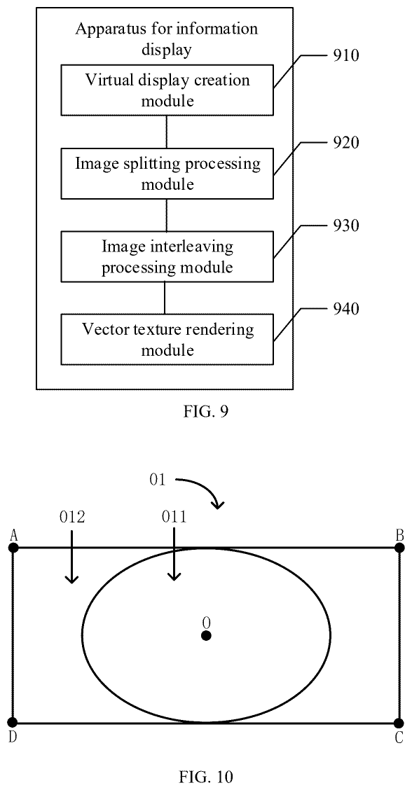

According to some embodiments of the present disclosure, there is further provided an apparatus for information display, which is configured in a terminal device. In some embodiments, referring to FIG. 9, the apparatus for information display may include a virtual display creation module 910, an image splitting processing module 920, an image interleaving processing module 930, and a vector texture rendering module 940.

The virtual display creation module 910 may be configured to create a global container and a virtual display corresponding to the terminal device.

The image splitting processing module 920 may be configured to perform, based on a naked-eye 3D film parameter of the virtual display, image splitting processing on a resource to be displayed to obtain left-right eye views with a naked-eye 3D effect.

The image interleaving processing module 930 may be configured to perform image interleaving processing on the left-right eye views to obtain a current vector texture corresponding to the resource to be displayed.

The vector texture rendering module 940 may be configured to push the current vector texture to the global container, and output the current vector texture to the virtual display based on the global container, to render the current vector texture by using the virtual display.

In some embodiments of the present disclosure, creating the virtual display corresponding to the terminal device includes: loading a graphics driver model in the terminal device; and, invoking a video present network function in the graphics driver model, and creating the virtual display by using the video present network function.

In some embodiments of the present disclosure, the apparatus for information display further includes:
an extended display identification data obtaining module, configured to obtain extended display identification data of a main display of the terminal device;
an original viewpoint number determination module, configured to determine, based on the extended display identification data, an original screen resolution, an original screen refresh rate, and a number of original viewpoints supportable by the main display; and
a naked-eye 3D film parameter generation module, configured to generate, according to the original screen resolution, the original screen refresh rate, and the number of original viewpoints, the naked-eye 3D film parameter of the virtual display.

In some embodiments of the present disclosure, creating the global container corresponding to the terminal device includes: invoking an integrated graphics card in the terminal device based on a multimedia programming interface in the terminal device, and creating the global container corresponding to the terminal device by using the integrated graphics card, where the global container is a modal container, and a background of the global container is a transparent background.

In some embodiments of the present disclosure, performing, based on the naked-eye 3D film parameter of the virtual display, image splitting processing on the resource to be displayed to obtain the left-right eye views with the naked-eye 3D effect includes: intercepting the resource to be displayed based on a graphics driver model, and establishing a path between the graphics driver model and the integrated graphics card based on a multimedia programming interface in the terminal device; transmitting the resource to be displayed to the integrated graphics card based on the path between the graphics driver model and the integrated graphics card, and caching the resource to be displayed in the integrated graphics card to a memory processor based on the multimedia programming interface; and performing, in the memory processor, image splitting processing on the resource to be displayed based on the naked-eye 3D film parameter of the virtual display to obtain the left-right eye views with the naked-eye 3D effect.

In some embodiments of the present disclosure, performing, based on the naked-eye 3D film parameter of the virtual display, image splitting processing on the resource to be displayed to obtain the left-right eye views with the naked-eye 3D effect includes: determining, based on the naked-eye 3D film parameter of the virtual display, a number of target viewpoints supportable by the virtual display; and performing image splitting processing on the resource to be displayed based on the number of target viewpoints to obtain the left-right eye views with the naked-eye 3D effect.

In some embodiments of the present disclosure, performing image interleaving processing on the left-right eye views to obtain the current vector texture corresponding to the resource to be displayed includes: invoking a vertex shader and a fragment shader in a memory processor, and calculating an interpolation range of the left-right eye views based on the vertex shader; calculating interpolation content of the left-right eye views based on the fragment shader; and performing image interleaving processing on the left-right eye views according to the interpolation range and the interpolation content to obtain the current vector texture corresponding to the resource to be displayed.

In some embodiments of the present disclosure, calculating the interpolation range of the left-right eye views based on the vertex shader includes: determining an image display range of the left-right eye views on the virtual display, and determining a vertex position of each pixel vertex in the left-right eye views on the virtual display according to the image display range; and determining the interpolation range of a naked-eye 3D resource by using the vertex shader according to the vertex position of each pixel vertex on the virtual display.

In some embodiments of the present disclosure, calculating the interpolation content of the left-right eye views based on the fragment shader includes: obtaining a color value arrangement rule of the virtual display, where the color value arrangement rule includes a pixel interval, a number of screen lines, and a maximum offset; determining a viewpoint interleaving rule of the virtual display according to the number of target viewpoints supportable by the virtual display by using the fragment shader; and calculating interpolation content of the left-right eye views according to the viewpoint interleaving rule and the color value arrangement rule.

In some embodiments of the present disclosure, determining the viewpoint interleaving rule of the virtual display according to the number of target viewpoints supportable by the virtual display by using the fragment shader includes: determining an original pixel matrix of the naked-eye 3D resource; performing, according to the number of target viewpoints supportable by the virtual display, an orthogonal change of human eye projection corresponding to the number of target viewpoints in the fragment shader to obtain a shader pixel matrix; and determining the viewpoint interleaving rule of the virtual display according to the shader pixel matrix and the original pixel matrix.

In some embodiments of the present disclosure, determining the viewpoint interleaving rule of the virtual display according to the shader pixel matrix and the original pixel matrix includes: calculating a product operation result between the shader pixel matrix and the original pixel matrix, and determining the viewpoint interleaving rule of the virtual display according to the product operation result.

In some embodiments of the present disclosure, pushing the current vector texture to the global container, and outputting the current vector texture to the virtual display based on the global container includes: pushing the current vector texture to the global container, and pushing, based on a multimedia programming interface, the current vector texture in the global container to an independent graphics card in the terminal device; replacing a historical vector texture in the independent graphics card based on the current vector texture, and transmitting the current vector texture in the independent graphics card to the virtual display based on the video signal transmission interface in the terminal device.

In some embodiments of the present disclosure, the naked-eye 3D resource includes at least one of a game scene, a video, and an image, and the apparatus information display further includes:
a first interaction module, configured to perform interaction with a game scene displayed in the virtual display based on a human eye fixation point; and/or
a second interaction module, configured to perform, based on an external input event, interaction with a game scene and/or a video and/or an image displayed in the virtual display.

In some embodiments of the present disclosure, performing interaction with the game scene displayed in the virtual display based on the human eye fixation point includes: obtaining a current fixation point position of the human eye fixation point in the virtual display, and obtaining a central point position of the virtual display; calculating a position angle between the current fixation point position and the central point position, and controlling a virtual lens in the game scene to rotate from a current position to a target lens position corresponding to the position angle; and displaying a scene picture shot by the virtual lens at the target lens position.

In some embodiments of the present disclosure, performing, based on the external input event, interaction with the game scene and/or the video and/or the image displayed in the virtual display includes: capturing, based on the global container, an external input event acting on the game scene and/or the video and/or the image by using the virtual display; and, transparently transmitting the external input event to an event processing layer based on the global container, and processing the external input event based on the event processing layer, to implement interaction with the game scene and/or the video and/or the image.

The specific details of each module in the above apparatus information display have been described in detail in the corresponding method for information display, and thus will not be repeated here.

It should be noted that although several modules or units of the device for action execution are mentioned in the above detailed description, such division is not mandatory. In fact, according to embodiments of the present disclosure, the features and functions of two or more modules or units described above may be embodied in one module or unit. Conversely, the features and functions of one module or unit described above may be further divided into a plurality of modules or units.

In addition, although various steps of the methods in the present disclosure are described in a particular order in the accompanying drawings, this does not require or imply that these steps must be performed in that particular order, or that all illustrated steps must be performed to implement the desired results. Additionally or alternatively, some steps may be omitted, more than one step may be combined into one step for execution, and/or one step may be decomposed into more than one step for execution.

In some embodiments of the present disclosure, there is further provided a display method, which is performed by a terminal device and includes following steps.

In S10, a global container and a virtual display corresponding to the terminal device are created. In some embodiments, the terminal device may be a display terminal. With respect to the process of creating a global container and a virtual display corresponding to the terminal device, reference may be made to the above step S110, which is not repeated below.

In S11, a display-hidden state of a target pixel is determined according to an original position of the target pixel in an image to be displayed that is obtained and/or a rotation angle of the display terminal that is received.

The image to be displayed in the present disclosure may be a resource to be displayed, for example, may be a video frame or image to be displayed that is loaded by a target application, or may be a game scene video frame or image to be displayed that is loaded by the target application, or may be a video frame or image to be displayed that is directly selected, which is not specially limited in the present disclosure.

Here, gravity sensing technology may be used to monitor whether the display terminal has rotated. When it is determined that rotation has occurred, the display-hidden state of each pixel in the image to be displayed is determined. “Gravity sensing” which is also known as gravity sensing or gravity sensor, refers to the technology that can detect and measure the gravitational field generated by the Earth or other objects. In a display device, such as a smartphone, a tablet computer, a wearable device, or a game controller, gravity sensing is usually implemented by built-in sensors that can sense the orientation, tilt angle, and motion state of the device. In a smartphone or a tablet computer, gravity sensing allows the device to automatically adjust the screen's orientation to adapt to the user's viewing angle (i.e., a function of auto-rotation). In games and sports applications, gravity sensing is used to detect tilt and motion of the device, so as to provide an intuitive gaming control experience.

For example, a sensor for detecting the posture state and a processor are integrated in a display terminal. The sensor collects the posture data of the display terminal (including but not limited to angular velocity, acceleration, speed, magnetic field direction, etc.) and uploads it to the processor. The processor determines whether the device has rotated based on the posture data. The processor can calculate the current rotation angle of the display terminal through the posture data. If the rotation angle is greater than a set value (e.g., 0 or 1°), a rotation command is initiated to detect the display-hidden state of each pixel in the image to be displayed.

The Graphics Processing Unit (GPU) in the display terminal typically pre-renders one or more frames of images as images to be displayed and stores them in a buffer for display. Taking a pixel (denoted as the target pixel) in an image to be displayed as an example, the original position of the target pixel in the image to be displayed and the currently calculated rotation angle are known. In some embodiments, the display-hidden state of the target pixel may be determined based on the obtained original position of the target pixel in the image to be displayed. In some embodiments, the display-hidden state of the target pixel may be determined based on the obtained original position of the target pixel in the image to be displayed and the received rotation angle of the display terminal. The display-hidden state includes a “display” state (hereinafter referred to as “display”) and a “hidden” state (hereinafter referred to as “hidden”).

In S12, image splitting processing is performed on a sub-image whose display-hidden state is a display state in the image to be displayed, to obtain left-right eye views with a naked-eye 3D effect corresponding to the sub-image.

In some embodiments, image splitting processing may be performed on the sub-image based on a naked-eye 3D film parameter of the virtual display that is pre-created, to obtain left-right eye views with a naked-eye 3D effect. Among them, the naked-eye 3D film parameter is the parameter configured for the virtual display after the virtual display is created successfully. The specific configuration process will be described later and will not be detailed here. For example, the naked-eye 3D film parameter includes, but is not limited to, the number of target viewpoints supported by the virtual display.

Here, two buffers are used in the present disclosure to buffer the sub-images with the display state and the sub-images with the hidden state in the image to be displayed. Two buffers are used to alternately display the image to avoid a screen tearing phenomenon. Since rotation is added to the dual-channel in the present disclosure, multiple layers of dual-channel are required to ensure rendering during subsequent rotation processes.

In S13, in a case that the display-hidden state of the target pixel is the display state, a current refresh position of the target pixel is determined based on at least the original position of the target pixel.

In some embodiments, the current refresh position of the target pixel may be determined based on the original position of the target pixel.

In some embodiments, the current refresh position of the target pixel may be determined based on the original position of the target pixel and the rotation angle of the display terminal. The rotation angle of the display terminal also refers to the rotation angle of the target pixel.

In S14, image interleaving processing is performed on the left-right eye views, and the original position of the naked-eye 3D image after interleaving is updated according to the current refresh position to obtain a target stereoscopic image with naked-eye 3D effect after rotation.

The purpose of performing image interleaving processing on the left-right eye views is to create a naked-eye 3D effect by interleaving. The original position of the target pixel whose display-hidden state is a display state in the naked-eye 3D image after interleaving is updated according to the current refresh position, to obtain the target stereoscopic image after rotation, thus achieving a naked-eye 3D display effect during the rotation process.

It is to be emphasized that S12 and S13 are executed after S11, but there is no specific order between S12 and S13. S12 and S13 may be performed synchronously. That is, while the current refresh position is calculated, the sub-image may be split. In this way, interleaving and rendering may be performed in real time on the left-right eye views during image rotation, thus achieving a seamless transition from 2D to 3D, and avoiding black screen in the process. This ensures that the display of naked-eye 3D related content is completed during the rotation.

In some embodiments, a processing technique of performing regionalization on the image is used to perform frequency processing of different interleaving on the sub-image with the display state and the sub-image with the hidden state, so as to satisfy the saving performance requirement and achieve real-time interleaving effect during rotation. Simultaneously, during rotation, the rotated image frames are preprocessed, only the sub-images with the display state are interleaved per frame, and the interleaving area and content between consecutive frames are dynamically processed.

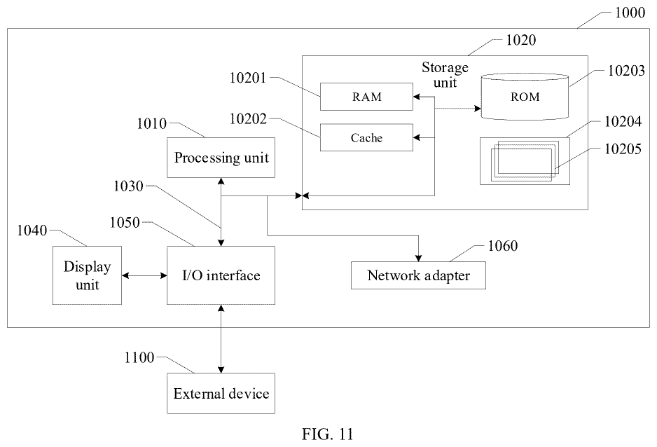

FIG. 10 is a distribution diagram of sub-areas divided for the display terminal provided in the embodiments of the present disclosure. As shown in FIG. 10, the display terminal has a display area 01, which is used to display image frames. The display area 01 is pre-divided into multiple display sub-areas, which respectively include a center point O, a first sub-area 011, a second sub-area 012, and a third sub-area. Among them, the first sub-area 011 is an inscribed elliptical sub-area with the center point O of the display area 01 as its center and the shortest distance from the center point O to the edge of the display area 01 as its short semi-axis. Taking the outer contour of the display area 01 being a rectangle as an example, the short semi-axis of the inscribed elliptical sub-area is half the width of the rectangle, and the long semi-axis of the inscribed elliptical sub-area extends in the direction of the long side of the rectangle. The size of the long semi-axis of the inscribed elliptical sub-area is greater than the size of the short semi-axis and less than half the size of the long side of the rectangle. The specific value of the size of the long semi-axis may be set according to the actual situation of the product and experience. The first sub-area 011 does not include the center point O. The second sub-area 012 is the remaining irregularly shaped area within display area 01, excluding the center point O, the first sub-area 011, and the vertices of display area 01 (vertices A, B, C, and D). The third sub-area includes multiple vertices within the display area 01, namely vertices A, B, C, and D. A pixel in the image to be displayed (such as the target pixel) may fall into any of the display sub-areas.

The principle of the above display sub-area division is that, during and after image rotation, there is a difference from the normal angle. During the swapping of the long side and the short side (the width and the height of the screen), the overall image is rotating around the center of the rectangle. In other words, the resulting image is a long-radius circular pattern formed around the diagonal of the rectangle. This constant macroscopic change is the axiomatic factor for achieving adaptation. For the rotation process, in addition to generating the extreme image value of the long radius, its short radius (i.e., the short semi-axis of the inscribed elliptical sub-area) also forms a corresponding circular pattern. The relationship between these two is that the short radius is a rapidly changing value, while the long radius is a slowly changing value. The reason for this is that during rotation, the refresh rate of the part closer to the screen center needs to match the screen's own refresh rate more closely, while at the far end, only when the extreme value is reached will the long-radius part be re-displayed as an image. Therefore, the overall screen texture is in a variable refresh rate state during rotation. Based on this, in the embodiments of the present disclosure, the above-mentioned multiple display sub-areas are divided according to the division manner shown in FIG. 2.

In some embodiments, for S11, determining the display-hidden state of the target pixel includes: in a case that the original position of the target pixel is known and the original position of the target pixel is located in the first sub-area, determining the display-hidden state of the target pixel to be a display state.

For example, for an ultra-high resolution image, such as a image to be displayed with 4K resolution, its center coordinates are (1920, 1080), its width is 3840 pixels, and its height is 2160 pixels. The range of the first sub-area 011 is the inscribed elliptical sub-area of the rectangle. The standard equation of a circle (x−h)²+(y−k)²≤r² may be used to determine whether the target pixel is located in the first sub-area 011. Here, (x, y) represents the original position of the target pixel. Without adding eye-tracking coefficients, (h, k) represents the center coordinates of the circle, i.e., (1920, 1080). With eye-tracking coefficients added, an equation for eye-tracking coefficients needs to be added based on (h, k), where h represents the arc length of the long side of the rectangle, and k represents the arc length of the short side of the rectangle.

In some embodiments, the first sub-area 011 may also be a circular sub-area with the center point O of the display area 01 as the center and the shortest distance from the center point O to the edge of the display area 01 as the radius. The first sub-area 011 does not include the center point O. Therefore, the target pixel located in the first sub-area 011 will be displayed in real time regardless of the rotation degree.

In some embodiments, for S11, determining the display-hidden state of the target pixel includes: in a case that the original position of the target pixel is known and the original position of the target pixel is located in the second sub-area, determining the display-hidden state of the target pixel based on the rotation angle of the target pixel.

As shown in FIG. 10, the second sub-area 012 is the remaining irregularly shaped area in the display area 01, excluding the center point O, the first sub-area 011, and the vertices of the display area (vertices A, B, C, and D). The second sub-area 012 is displayed at a certain rotation angle and will be hidden after exceeding a certain rotation angle. Therefore, it is necessary to further determine the display-hidden state based on the rotation angle of the target pixel.

In some embodiments, the display-hidden state of the target pixel located in the second sub-area may be determined based on the rotation angle of the target pixel and the screen refresh rate. In some embodiments, when the rotation angle is between a first set value and a second set value, the display-hidden state of the target pixel located in the second sub-area is determined to be a display state; the first set value is 1/f, and the second set value is −1/f, where f represents the screen refresh rate of the display terminal. When the rotation angle is not between the first set value and the second set value, the display-hidden state of the target pixel located in the second sub-area is determined to be a hidden state. Taking a screen refresh rate of 60 Hz as an example, when the rotation angle is between −16.67° and 16.67°, including the endpoint value, the display-hidden state of the target pixel is determined to be a display state; when the rotation angle exceeds the range of −16.67° to 16.67°, including the endpoint value, the display-hidden state of the target pixel is determined to be a hidden state.

In some embodiments, for S11, determining the display-hidden state of the target pixel includes: in a case that the original position of the target pixel is known and the original position of the target pixel is located in the third sub-area, determining the display-hidden state of the target pixel based on the rotation angle of the target pixel.

As shown in FIG. 10, the third sub-area includes multiple vertices of the display area (vertices A, B, C, and D). Therefore, target pixels located in the third sub-area only may be displayed under extreme rotation values, such as 0°, ±90°, or ±180°. That is, in a case that the rotation angle is 0°, ±90°, or ±180°, the display-hidden state of the target pixel in the third sub-area is determined to be a display state. In a case that the rotation angle is not 0°, ±90°, or ±180°, the display-hidden state of the target pixel in the third sub-area is determined to be a hidden state.

In some embodiments, for S11, determining the display-hidden state of the target pixel includes: in a case that the original position of the target pixel is known and the original position of the target pixel is located at the center point, determining the display-hidden state of the target pixel to be a display state. Since the position and pixel value of the target pixel at the center of the image do not change regardless of how many degrees it is rotated, it remains in the display state.

Since only the sub-image with the display state (referred to as the display sub-image) is displayed during the rotation process, it only requires calculating the current refresh position of the display sub-image when the rotation position (i.e. the current refresh position) is determined subsequently.

In some embodiments, for S13, for a target pixel located in the first sub-area or the second sub-area, the current refresh position of the target pixel may be determined according to the original position of the target pixel and the rotation angle of the display terminal. In some embodiments, the process includes S13-1-1 to S13-1-2.

In S13-1-1, in a case that the display-hidden state of the target pixel is the display state, a rotation matrix is determined based on the rotation angle of the target pixel.

The rotation matrix for the target pixel may be determined according to Formula 1.

Formula 1: R(θ)=cos(θ)−sin(θ)×sin(θ)×cos(θ); where R(θ) represents the rotation matrix for the target pixel; θ represents the rotation angle; cos( ) represents the cosine operation; sin( ) represents the sine operation.

For a rotation of 1°, it may also be converted to radians for calculation, in which case the rotation matrix is obtained according to

$$R ( 1 ° ) = cos ( \frac{π}{180} ) - sin ( \frac{π}{180} ) \times sin ( \frac{π}{180} ) \times cos ( \frac{π}{180} ) .$$

In S13-1-2, the current refresh position of the target pixel is determined based on the rotation matrix, the original position of the target pixel, and the rotation angle.

The current refresh position of the target pixel may be determined using Formula 2.

$$\{ \begin{matrix}{x}^{′} = R ( θ ) + ( x - R ( θ ) ) cos ( θ ) - ( y - R ( θ ) ) sin ( θ ) \\ {y}^{′} = R ( θ ) + ( x - R ( θ ) ) sin ( θ ) + ( y - R ( θ ) ) cos ( θ )\end{matrix} ; where ( {x}^{′} , {y}^{′} ) \qquad Formula 2$$

represents the current refresh position; R(θ) represents the rotation matrix; (x, y) represents the original position; θ represents the rotation angle; cos( ) represents the cosine operation; sin( ) represents the sine operation.

In some embodiments, for S13, for a target pixel located in the third sub-area, the current refresh position of the target pixel may be determined based on the original position of the target pixel. The specific process includes S13-2-1.

In S13-2-1, in a case that the display-hidden state is the display state, the maximum value and the minimum value in the same direction in the original position are swapped to obtain the current refresh position of the target pixel.

For example, the original positions of the target pixels located at the four vertices in the image to be displayed are A (xmin, ymin), B (xmin, ymax), C (xmax, ymin), and D (xmax, ymax), respectively. For target pixel A (xmin, ymin), its current refresh position after rotation is A′ (xmax, ymax); for target pixel B (xmin, ymax), its current refresh position after rotation is B′ (xmax, ymin); for target pixel C (xmax, ymin), its current refresh position after rotation is C′ (xmin, ymax); and for target pixel D (xmax, ymax), its current refresh position after rotation is D′ (xmin, ymin).

In some embodiments, for S13, for a target pixel located at the center point, the current refresh position of the target pixel may be determined based on the original position of the target pixel. The specific process includes S13-3-1.

In S13-3-1, the original position is used as the current refresh position of the target pixel after rotation.

Since the rotation angle of the target pixel located at the center point does not affect its position, the position of the target pixel located at the center point remains unchanged and will always be displayed, regardless of how many degrees it is rotated.

In some embodiments, for S11, the step of determining the rotation angle of the display terminal includes S111 to S112.

In S111, the data collected by gravity sensors integrated in the display terminal is obtained.

Here, the gravity sensors include an accelerometer, a gyroscope, and a magnetometer. Among them, the accelerometer may measure linear acceleration along three axes (typically X, Y, and Z axes), including acceleration due to gravity. By analyzing the data from accelerometer, the static posture and dynamic motion of the display terminal may be determined. The gyroscope may measure angular velocities around the three axes, helping to determine the rotation and tilt angles of the device. While the magnetometer does not directly measure gravity, it may detect the direction of magnetic fields, which may be combined with the accelerometer and gyroscope data to determine the orientation and posture of the display terminal more accurately.

In S112, the posture of the display terminal is analyzed based on the collected data, and the rotation angle is determined.

By combining data collected from the accelerometer, the gyroscope, and the magnetometer, the posture of the display terminal is analyzed, and the current rotation angle of the display terminal is finally obtained.

In some embodiments, the manner of detecting the rotation angle of the display terminal is not limited to the gravity sensing manner described above. Other devices for collecting posture data may also be selected, which is not limited in the embodiments of the present disclosure.

For ease of understanding, an example is used to illustrate the overall process of determining the current refresh position of a target pixel in the present disclosure. In some embodiments, the process of determining the current refresh position of a target pixel includes S21˜S213.

In S21, the display sub-area where the target pixel is located is determined based on the original position of the target pixel.

In S22, in a case that it is located in the first sub-area, the display-hidden state of the target pixel is determined to be the display state, and S210 is executed next.

In S23, in a case that it is located in the second sub-area, determine whether the rotation angle is within ±1/f; if yes, S26 is executed; if no, S27 is executed.

In S24, in a case that it is located in the third sub-area, determine whether the rotation angle is any one of 0°, ±90° or ±180°; if yes, S28 is executed; if no, S29 is executed.

In S25, in a case that it is located at the center point, the display-hidden state of the target pixel is determined to be the display state, and S213 is executed next.

In S26, the display-hidden state of the target pixel is determined to be the display state, and S210 is executed next.

In S27, the display-hidden state of the target pixel is determined to be the hidden state.

In S28, the display-hidden state of the target pixel is determined to be the display state, and S212 is executed next.

In S29, the display-hidden state of the target pixel is determined to be the hidden state.

In S210, the rotation matrix is determined based on the rotation angle of the target pixel, and S211 is executed sequentially.

In S211, the current refresh position of the target pixel is determined based on the rotation matrix, the original position of the target pixel, and the rotation angle.

In S212, the maximum value and the minimum value in the same direction in the original position are swapped to obtain the current refresh position of the target pixel.

In S213, the original position is used as the current refresh position of the target pixel after rotation.

For ease of understanding, an example is used to illustrate the overall flow of the display method in the present disclosure. In some embodiments, the display method includes S31 to S34.

In S31, it is detected whether a rotational motion has occurred.

In S32, in response to an instruction that rotation occurs, the sub-image whose display-hidden state is a display state is determined.

In S33, image splitting and interleaving is performed on the sub-image, and simultaneously, the current refresh position of each pixel in the sub-image is calculated comprehensively.

In S34, the original position of the naked-eye 3D image after interleaving is updated according to the current refresh position to obtain the target stereoscopic image with naked-eye 3D effect after rotation.

In some embodiments, the specific process of interleaving and rendering includes S141 to S143.

In S141, image interleaving processing is performed on the left-right eye views to obtain a first vector texture corresponding to the sub-image.

The left-right eye views include a left eye view and a right eye view. In response to receiving the eye-tracking data, interleaving is performed on the pixels in the left eye view and the pixels in the right eye view by using the eye-tracking data. In some embodiments, an image interweaving algorithm may be used to calculate the pixel interweaving logic in real time according to the eye coordinates indicated by the eye-tracking data. For example, pixels suitable for the left eye are selected from the left eye view, and pixels suitable for the right eye are selected from the right eye view. Both of these pixels are interwoven to create a naked-eye 3D texture that is adapted to the human eye and then output.

In the step S141, a global soft interleaving scheme may be used, which includes S1411 to S1413.

In S1411, a vertex shader and a fragment shader in the memory processor are invoked, and an interpolation range of the left-right eye views is calculated based on the vertex shader. In some embodiments, firstly, the image display range of the left-right eye views on the virtual display may be determined. Secondly, based on the image display range, the vertex position of each pixel vertex in the left-right eye views on the virtual display may be determined. Finally, the interpolation range of the left-right eye views may be determined based on the vertex position of each pixel vertex on the virtual display by using the vertex shader.

In S1412, interpolation content of the left-right eye views is calculated based on the fragment shader. In some embodiments, firstly, a color value arrangement rule of the virtual display is obtained, where the color value arrangement rule includes a pixel interval, a number of screen lines, and a maximum offset. Secondly, a viewpoint interleaving rule of the virtual display is determined according to the number of target viewpoints supportable by the virtual display by using the fragment shader. Finally, the interpolation content of the left-right eye views is calculated according to the viewpoint interleaving rule and the color value arrangement rule.

In some embodiments, determining the viewpoint interleaving rule of the virtual display according to the number of target viewpoints supportable by the virtual display by using the fragment shader may be implemented in the following manner. Firstly, an original pixel matrix of the naked-eye 3D resource is determined; secondly, according to the number of target viewpoints supportable by the virtual display, an orthogonal change of human eye projection corresponding to the number of target viewpoints is performed in the fragment shader to obtain a shader pixel matrix; finally, the viewpoint interleaving rule of the virtual display is determined according to the shader pixel matrix and the original pixel matrix.

In some embodiments, determining the viewpoint interleaving rule of the virtual display according to the shader pixel matrix and the original pixel matrix may be implemented in the following manner. Firstly, a product operation result between the shader pixel matrix and the original pixel matrix is calculated; and then, the viewpoint interleaving rule of the virtual display is determined according to the product operation result.

In S1413, based on the interpolation range and the interpolation content, image interleaving processing is performed on the left-right eye views to obtain the first vector texture.

In S142, the first vector texture is updated according to the current refresh position to obtain a second vector texture after rotation.

In some embodiments, the first vector texture may be updated according to the current refresh position to adapt the rotation angle to the texture, thus replacing the first vector texture that should be displayed and obtaining the second vector texture after rotation.

In S143, the second vector texture is pushed to a pre-created global container, and the second vector texture is output to the virtual display based on the global container, so as to render the second vector texture by using the virtual display and obtain the target stereoscopic image.

In some embodiments, the second vector texture is pushed to the global container, and the second vector texture in the global container is pushed to an independent graphics card in the terminal device based on a multimedia programming interface; and, a historical vector texture in the independent graphics card is replaced based on the second vector texture, and the second vector texture in the independent graphics card is transmitted to the virtual display based on a video signal transmission interface in the terminal device. In an actual application process, after the second vector texture is obtained, the second vector texture may be pushed to a full-screen container by using a corresponding data stream pushing channel; and, after the full-screen container receives the second vector texture, the second vector texture may be pushed to the independent graphics card based on the multimedia programming interface. Then, the independent graphics card replaces the historical vector texture in the independent graphics card based on the second vector texture, and assembles the set of pixel vertexes into points, straight lines and triangles based on the interpolation range in the second vector texture, thus achieving the purpose of improving the rendering speed of the model to be rendered and the scene to be rendered in the sub-image to be rendered.

For example, the second vector texture in the discrete graphics card is transmitted to the virtual display based on the video signal transmission interface in the display device, where the video signal transmission interface may include a high definition multimedia interface (HDMI) or a DisplayPort (DP) interface. After the virtual display receives the second vector texture, the second vector texture may be rendered to implement display of the sub-image.

In some embodiments of the present disclosure, there is further provided a non-transitory computer-readable storage medium having a computer program stored thereon. When the computer program is executed by a processor, the above display method is implemented.

In some embodiments of the present disclosure, there is further provided an electronic device capable of implementing the above method for information display or the above display method.

Those skilled in the art can understand that various aspects of the present disclosure may be implemented as a system, a method, or a program product. Therefore, various aspects of the present disclosure may be specifically implemented in the following form: a complete hardware implementation, a complete software implementation (including firmware, microcode, etc.), or an implementation combining hardware and software, which may be collectively referred to here as “circuit”, “module”, or “system”.

The electronic device 1000 according to this embodiment of the present disclosure will be described below with reference to FIG. 11. The electronic device 1000 shown in FIG. 11 is merely an example, and should not bring any limitation to the function and scope of use of the embodiments of the present disclosure.

As shown in FIG. 11, the electronic device 1000 is represented in a form of a general-purpose computing device. Components of the electronic device 1000 may include, but are not limited to, at least one processing unit 1010, at least one storage unit 1020, a bus 1030 connected to different system components (including the storage unit 1020 and the processing unit 1010), and a display unit 1040.

In some embodiments, the storage unit stores program code, and the program code may be executed by the processing unit 1010 to enable the processing unit 1010 to perform steps according to various example embodiments of the present disclosure described in the “example method” part described in the present specification. For example, the processing unit 1010 may perform: step S110, creating a global container and a virtual display corresponding to the terminal device; step S120, performing, based on a naked-eye 3D film parameter of the virtual display, image splitting processing on a resource to be displayed to obtain left-right eye views with a naked-eye 3D effect; step S130, performing image interleaving processing on the left-right eye views to obtain a current vector texture corresponding to the resource to be displayed; and step S140, pushing the current vector texture to the global container, and outputting the current vector texture to the virtual display based on the global container, to render the current vector texture by using the virtual display, as shown in FIG. 1.

The storage unit 1020 may include a readable medium in the form of a volatile storage unit, such as a random access storage unit (RAM) 10201 and/or a cache storage unit 10202, and may further include a read-only storage unit (ROM) 10203.

The storage unit 1020 may further include a program/utility 10204 having a set (at least one) of program modules 10205. Such program module 10205 includes, but is not limited to, an operating system, one or more applications, other program modules, and program data. Each or a certain combination of these examples may include an implementation of a network environment.

The bus 1030 may be one or more buses that represent several types of bus structures, including a memory unit bus or a memory unit controller, a peripheral bus, a graphics acceleration port, a processing unit, or a local bus using any of a plurality of bus structures.

The electronic device 1000 may also communicate with one or more external devices 1100 (e.g., a keyboard, a pointing device, a Bluetooth device, etc.), may also communicate with one or more devices that enable a user to interact with the electronic device 1000, and/or may communicate with any device (e.g., a router, modem, etc.) that enables the electronic device 1000 to communicate with one or more other computing devices. Such communication may occur via an input/output (I/O) interface 1050. In addition, the electronic device 1000 may communicate with one or more networks, such as a local area network (LAN), a wide area network (WAN), and/or a public network, such as the Internet, through a network adapter 1060. As shown, the network adapter 1060 communicates with other modules of electronic device 1000 via bus 1030. It should be understood that although not shown in the figure, other hardware and/or software modules may be used in combination with the electronic device 1000, including but not limited to: microcode, a device driver, a redundancy processing unit, an external disk drive array, a RAID system, a tape driver, a data backup storage system, or the like.

Through the description of the foregoing implementations, those skilled in the art may easily understand that the example implementations described here may be implemented by software, or may be implemented by software in combination with necessary hardware. Therefore, the technical solutions according to the embodiments of the present disclosure may be embodied in the form of a software product, and the software product may be stored in a non-volatile storage medium (which may be a CD-ROM, a USB flash disk, a mobile hard disk, etc.) or a network, and includes several instructions to cause a computing device (which may be a personal computer, a server, a terminal device, or a network device, etc.) to perform the method according to the embodiments of the present disclosure.

In some embodiments of the present disclosure, there is further provided a computer-readable storage medium, on which a program product capable of implementing the method described in this present specification is stored. In some possible implementations, various aspects of the present disclosure may also be implemented in a form of a program product, including program code; and when the program product runs on a terminal device, the program code is configured to cause the terminal device to perform the steps described in the “example method” part of the present specification according to various example embodiments of the present disclosure.

According to embodiments of the present disclosure, the program product for implementing the above method may use a portable compact disk read-only memory (CD-ROM) and include program code, and may run on a terminal device, for example, a personal computer. However, the program product of the present disclosure is not limited to this. In the present document, the readable storage medium may be any tangible medium containing or storing a program, and the program may be used by or used in combination with an instruction execution system, apparatus or device.

The program product may adopt any combination of one or more readable media. The readable medium may be a readable signal medium or a readable storage medium. The readable storage medium may be, for example, but is not limited to, an electronic, magnetic, optical, electromagnetic, infrared, or semiconductor system, apparatus, or device, or any combination of the foregoing. A more specific example of a readable storage medium (a non-exhaustive list) includes an electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The computer readable signal medium may include a data signal propagated in a baseband or as part of a carrier, in which readable program code is carried. The propagated data signal may take a variety of forms, including but not limited to an electromagnetic signal, an optical signal, or any suitable combination of the foregoing. A readable signal medium may also be any readable medium other than a readable storage medium, and the readable medium may send, propagate, or transmit a program for use by or in connection with an instruction execution system, an apparatus, or a device.

The program code included in the readable medium may be transmitted by using any suitable medium, including but not limited to wireless, wired, optical cable, RF, etc., or any suitable combination of the foregoing.

Program code for performing the operations of the present disclosure may be written in any combination of one or more programming languages, including object-oriented programming languages, such as Java, C++, etc., as well as conventional procedural programming languages, such as the “C” language or similar programming languages. The program code may be executed entirely on the user computing device, partially on the user device, as a stand-alone software package, partially on the user computing device and partially on the remote computing device, or entirely on the remote computing device or server. In the case of involving a remote computing device, the remote computing device may be connected to the user computing device through any type of network, including a local area network (LAN) or a wide area network (WAN), or may be connected to an external computing device (e.g. connected through the Internet via an Internet service provider).

In addition, the accompanying drawings are merely schematic descriptions of processes included in the method according to the example embodiments of the present disclosure, and are not intended to be limiting. It is easy to understand that the processing shown in the above drawings does not indicate or limit the chronological order of these processes. In addition, it is also easy to understand that these processes may be performed synchronously or asynchronously, for example, in more than one module.

Other embodiments of the present disclosure will be apparent to those skilled in the art from consideration of the specification and practice of the present disclosure here. The present disclosure is intended to cover any variations, uses, or adaptations of the present disclosure, which follow the general principles of the present disclosure and include common general knowledge and conventional technical means in the art not disclosed in the present disclosure. It is intended that the specification and examples may be considered as examples only, with a true scope and spirit of the present disclosure being indicated by the following claims.

What is claimed is:

1. A display method, performed by a terminal device, and comprising:
creating a global container and a virtual display corresponding to the terminal device;
determining, according to at least one of an original position of a target pixel in an image to be displayed that is obtained or a rotation angle of the terminal device that is received, a display-hidden state of the target pixel;
performing image splitting processing on a sub-image whose display-hidden state is a display state in the image to be displayed based on a naked-eye 3D film parameter of the virtual display, to obtain left-right eye views corresponding to the sub-image;
in a case that the display-hidden state of the target pixel is the display state, determining a current refresh position of the target pixel based on at least the original position of the target pixel;
performing image interleaving processing on the left-right eye views to obtain a first vector texture corresponding to the sub-image;
updating the first vector texture according to the current refresh position to obtain a second vector texture after rotation; and
pushing the second vector texture to the global container, and outputting the second vector texture to the virtual display based on the global container, to obtain a target stereoscopic image by rendering the second vector texture using the virtual display.

2. The display method according to claim 1, wherein the terminal device is provided with a display area, the display area is pre-divided into multiple display sub-areas, the multiple display sub-areas comprise a center point, a first sub-area, a second sub-area, and a third sub-area, respectively; the first sub-area is an inscribed elliptical sub-area with a center point of the display area as a center and a shortest distance from the center point to an edge of the display area as a short semi-axis, and the first sub-area does not comprise the center point; the second sub-area is a remaining irregularly shaped area within display area, excluding the center point, the first sub-area, and vertices of the display area; and the third sub-area comprises the vertices of the display area.

3. The display method according to claim 2, wherein determining, according to at least one of the original position of the target pixel in the image to be displayed that is obtained or the rotation angle of the terminal device that is received, the display-hidden state of the target pixel comprises one of:
in a case that the original position of the target pixel is located in the first sub-area, determining the display-hidden state of the target pixel to be a display state; or
in a case that the original position of the target pixel is located in the second sub-area and the rotation angle of the terminal device is between a first set value and a second set value, determining the display-hidden state of the target pixel to be a display state based on the rotation angle of the terminal device, wherein the first set value is 1/f, the second set value is −1/f, and f represents a screen refresh rate of the terminal device.

4. The display method according to claim 2, wherein determining, according to at least one of the original position of the target pixel in the image to be displayed that is obtained or the rotation angle of the terminal device that is received, the display-hidden state of the target pixel comprises:
in a case that the original position of the target pixel is located in the third sub-area and the rotation angle of the terminal device is 0°, +90°, or +180°, determining the display-hidden state of the target pixel to be a display state.

5. The display method according to claim 2, wherein determining, according to at least one of the original position of the target pixel in the image to be displayed that is obtained or the rotation angle of the terminal device that is received, the display-hidden state of the target pixel comprises:
in a case that the original position of the target pixel is located at the center point, determining the display-hidden state of the target pixel to be a display state.

6. The display method according to claim 3, wherein in a case that the display-hidden state of the target pixel is the display state, determining the current refresh position of the target pixel based on at least the original position of the target pixel comprises:
determining a rotation matrix for the target pixel according to following formula,
$$R ( θ ) = cos ( θ ) - sin ( θ ) \times sin ( θ ) \times cos ( θ ) ,$$
wherein R(θ) represents the rotation matrix for the target pixel; θ represents the rotation angle; cos( ) represents the cosine operation; sin( ) represents the sine operation; and
determining the current refresh position of the target pixel based on the rotation matrix, the original position of the target pixel, and the rotation angle according to following formula,
$$\{ \begin{matrix}{x}^{′} = R ( θ ) + ( x - R ( θ ) ) cos ( θ ) - ( y - R ( θ ) ) sin ( θ ) \\ {y}^{′} = R ( θ ) + ( x - R ( θ ) ) sin ( θ ) + ( y - R ( θ ) ) cos ( θ )\end{matrix} ;$$
wherein (x′, y′) represents the current refresh position; R(θ) represents the rotation matrix; (x, y) represents the original position; θ represents the rotation angle; cos( ) represents the cosine operation; sin( ) represents the sine operation.

7. The display method according to claim 4, wherein in a case that the display-hidden state of the target pixel is the display state, determining the current refresh position of the target pixel based on at least the original position of the target pixel comprises:
swapping a maximum value and a minimum value in a same direction in the original position to obtain the current refresh position of the target pixel.

8. The display method according to claim 5, wherein in a case that the display-hidden state of the target pixel is the display state, determining the current refresh position of the target pixel based on at least the original position of the target pixel comprises:
using the original position as the current refresh position of the the target pixel after rotation.

9. The display method according to claim 1, wherein creating the virtual display and the virtual display corresponding to the terminal device comprises:
loading a graphics driver model in the terminal device, invoking a video present network function in the graphics driver model, and creating the virtual display by using the video present network function; and
invoking an integrated graphics card in the terminal device based on a multimedia programming interface in the terminal device, and creating the global container corresponding to the terminal device by using the integrated graphics card, wherein the global container is a modal container, and a background of the global container is a transparent background.

10. The display method according to claim 1, further comprising:
obtaining extended display identification data of a main display of the terminal device;
determining, based on the extended display identification data, an original screen resolution, an original screen refresh rate, and a number of original viewpoints supportable by the main display; and
generating, according to the original screen resolution, the original screen refresh rate, and the number of original viewpoints, the naked-eye 3D film parameter of the virtual display.

11. The display method according to claim 1, wherein performing image splitting processing on the sub-image whose display-hidden state is the display state in the image to be displayed based on the naked-eye 3D film parameter of the virtual display, to obtain the left-right eye views corresponding to the sub-image comprises:
intercepting the image to be displayed based on a graphics driver model, and establishing a path between the graphics driver model and an integrated graphics card based on a multimedia programming interface in the terminal device;
transmitting the sub-image to the integrated graphics card based on the path between the graphics driver model and the integrated graphics card, and caching the sub-image in the integrated graphics card to a memory processor based on the multimedia programming interface; and
performing, in the memory processor, image splitting processing on the sub-image based on the naked-eye 3D film parameter of the virtual display to obtain the left-right eye views corresponding to the sub-image.

12. The display method according to claim 1, wherein performing image splitting processing on the sub-image whose display-hidden state is the display state in the image to be displayed based on the naked-eye 3D film parameter of the virtual display, to obtain the left-right eye views corresponding to the sub-image comprises:
determining, based on the naked-eye 3D film parameter of the virtual display, a number of target viewpoints supportable by the virtual display; and
performing image splitting processing on the sub-image based on the number of target viewpoints to obtain the left-right eye views corresponding to the sub-image.

13. The display method according to claim 1, wherein performing image interleaving processing on the left-right eye views to obtain the first vector texture corresponding to the sub-image comprises:
invoking a vertex shader and a fragment shader in a memory processor, and calculating an interpolation range of the left-right eye views based on the vertex shader;
calculating interpolation content of the left-right eye views based on the fragment shader; and
performing image interleaving processing on the left-right eye views according to the interpolation range and the interpolation content to obtain the first vector texture.

14. The display method according to claim 13, wherein calculating the interpolation range of the left-right eye views based on the vertex shader comprises:
determining an image display range of the left-right eye views on the virtual display, and determining a vertex position of each pixel vertex in the left-right eye views on the virtual display according to the image display range; and
determining the interpolation range of the left-right eye views by using the vertex shader according to the vertex position of each pixel vertex on the virtual display.

15. The display method according to claim 13, wherein calculating the interpolation content of the left-right eye views based on the fragment shader comprises:
obtaining a color value arrangement rule of the virtual display, wherein the color value arrangement rule comprises a pixel interval, a number of screen lines, and a maximum offset;
determining a viewpoint interleaving rule of the virtual display according to the number of target viewpoints supportable by the virtual display by using the fragment shader; and
calculating the interpolation content of the left-right eye views according to the viewpoint interleaving rule and the color value arrangement rule.

16. The display method according to claim 15, wherein determining the viewpoint interleaving rule of the virtual display according to the number of target viewpoints supportable by the virtual display by using the fragment shader comprises:
determining an original pixel matrix of the resource to be displayed;
performing, according to the number of target viewpoints supportable by the virtual display, an orthogonal change of human eye projection corresponding to the number of target viewpoints in the fragment shader to obtain a shader pixel matrix; and
determining the viewpoint interleaving rule of the virtual display according to the shader pixel matrix and the original pixel matrix.

17. The display method according to claim 16, wherein determining the viewpoint interleaving rule of the virtual display according to the shader pixel matrix and the original pixel matrix comprises:
calculating a product operation result between the shader pixel matrix and the original pixel matrix; and
determining the viewpoint interleaving rule of the virtual display according to the product operation result.

18. The display method according to claim 1, wherein pushing the second vector texture to the global container, and outputting the second vector texture to the virtual display based on the global container comprises:
pushing the second vector texture to the global container, and pushing the second vector texture in the global container to an independent graphics card in the terminal device based on a multimedia programming interface; and
replacing a historical vector texture in the independent graphics card based on the second vector texture, and transmitting the second vector texture in the independent graphics card to the virtual display based on a video signal transmission interface in the terminal device.

19. A non-transitory computer-readable storage medium having a computer program stored thereon, wherein the computer program, when executed by a processor, implements a display method, and the display method comprises:
creating a global container and a virtual display corresponding to a terminal device;
determining, according to at least one of an original position of a target pixel in an image to be displayed that is obtained or a rotation angle of the terminal device that is received, a display-hidden state of the target pixel;
performing image splitting processing on a sub-image whose display-hidden state is a display state in the image to be displayed based on a naked-eye 3D film parameter of the virtual display, to obtain left-right eye views corresponding to the sub-image;
in a case that the display-hidden state of the target pixel is the display state, determining a current refresh position of the target pixel based on at least the original position of the target pixel;
performing image interleaving processing on the left-right eye views to obtain a first vector texture corresponding to the sub-image;
updating the first vector texture according to the current refresh position to obtain a second vector texture after rotation; and
pushing the second vector texture to the global container, and outputting the second vector texture to the virtual display based on the global container, to obtain a target stereoscopic image by rendering the second vector texture using the virtual display.

20. An electronic device, comprising:
a processor; and
a memory, configured to store an executable instruction by the processor;
wherein the processor is configured, by executing the executable instruction, to:
create a global container and a virtual display corresponding to the electronic device;
determine, according to at least one of an original position of a target pixel in an image to be displayed that is obtained or a rotation angle of the electronic device that is received, a display-hidden state of the target pixel;
perform image splitting processing on a sub-image with a display state in the image to be displayed based on a naked-eye 3D film parameter of the virtual display, to obtain left-right eye views corresponding to the sub-image;
in a case that the display-hidden state of the target pixel is the display state, determine a current refresh position of the target pixel based on at least the original position of the target pixel;
perform image interleaving processing on the left-right eye views to obtain a first vector texture corresponding to the sub-image;
update the first vector texture according to the current refresh position to obtain a second vector texture after rotation; and
push the second vector texture to the global container, and output the second vector texture to the virtual display based on the global container, to obtain a target stereoscopic image by rendering the second vector texture using the virtual display.
